(19) United States
(12) Patent Application Publication
(10) Pub. No.: US 2014/0089053 A1
(43) Pub. Date: Mar. 27, 2014

(54) PERPETUALLY DECREASING GROUP PRICING SYSTEM AND METHOD

(71) Applicant: Dan Iorga, Port Coquitlam (CA)

(72) Inventor: Dan Iorga, Port Coquitlam (CA)

(21) Appl. No.: 13/625,870

(22) Filed: Sep. 24, 2012

(51) Int. Cl. G06Q 30/02

(52) U.S. Cl. CPC G06Q 30/0206
USPC 705/7.35

(57) ABSTRACT

The present invention takes an input of the acceptable pricing to volume points from a business and outputs a continuous function which interpolates the pricing information for the entire range of customer volumes. As each consumer agrees to purchase an offer, they are added to the group, and the price decreases as defined by the output function. The result of this model is that of consumer collusion; it is in each consumer's best interest to increase the volume of purchases for the offer by the business. This yields lower prices for the individual, incentivizing each consumer to advertise for the business making the offer.

### CROSS-REFERENCE TO RELATED APPLICATIONS

This application claims the benefit of U.S. Provisional Patent Application No. 61/538,828, filed on Sep. 24, 2011, and incorporated herein by reference.

### STATEMENT REGARDING FEDERALLY SPONSORED RESEARCH AND DEVELOPMENT

Not Applicable.

### FIELD OF THE INVENTION

This invention relates generally to a perpetually decreasing group pricing system, and more particularly, to a system for defining discounted prices as a function of consumer purchase volume in a group discount setting.

### DISCUSSION OF RELATED ART

A pricing system is defined as any method which affects the distribution of goods or services by employing the use of price and money. Generally, pricing systems comprise two basic forms: the fixed price system and the free price system. Capitalist societies use the free price system, in which the price varies and purchases are generally dictated by the law of supply and demand.

The first law of supply and demand states that in an environment with fixed supply, an increase in demand will cause an increase in purchases and transactions. General economic theory states that an increase in purchase volume can be attained by increasing market share within a constant sized market, or increasing market size as a whole.

The group purchase model, made popular by Groupon™, attempts to increase demand by allowing consumers to leverage their purchasing power together in order to encourage a business to lower its prices. The effects of this are accepted by both the business and consumer because they each see their best interests served; the business has an increase in volume of purchases at the cost of an acceptably lowered price point, while the customer has a decrease in price in exchange for being a member of the group.

While the group purchase model has been successful, there are potential pitfalls and room for improvement. In its current form, if the consumer volume for a particular offer reaches a point magnitudes higher than the offer price, the price remains the same. This negatively affects customers who do not receive a lower price commensurate with their increased bargaining position. Therefore, a need exists for a group purchase model whose price declines as more buyers place orders, thus increasing the bargaining position of the group.

### SUMMARY OF THE INVENTION

Current pricing models are essentially limited by their discrete nature. The present invention implements a group purchase model whose price declines as more buyers place orders, thus increasing the bargaining position of the group. As such, businesses are no longer exposed to the risks of lowered price without increased volume, and consumers are no longer limited to a discrete price point independent of their overall bargaining position.

The present invention takes an input of the acceptable pricing to volume points from a business and outputs a continuous function which interpolates the pricing information for the entire range of customer volumes. As each consumer agrees to purchase an offer, they are added to the group, and the price decreases as defined by the output function. The result of this model is that of consumer collusion; it is in each consumer's best interest to increase the volume of purchases for the offer by the business. This yields lower prices for the individual, incentivizing each consumer to advertise for the business making the offer.

Further incentives for purchasing a given offer can be found in the implementation of a guessing game. Each offer is given during a timeframe determined by the business, and the consumer is offered a chance to guess the final price of the offer at the end of this time frame. The first consumer to accurately guess the ultimate price of the offer can be rewarded, for example, by having their purchase be made free. This encourages consumers to entertain multiple purchases on an offer in addition to attempting to recruit more consumers for their desired offer.

A costumer recognition platform within the present invention allows for the most recent consumer to have their name displayed as the user who “most recently lowered the price for everybody.” This further incentivizes purchases, by adding perceived value to each individual consumer. The consumers also gain an amount of control over what their ultimate price will be on an offer, which is missing from the previously mentioned pricing models.

These and other objectives of the present invention will become obvious to those of ordinary skill in the art after reading the following detailed description of the preferred embodiments. It is to be understood that the foregoing general description and the following detailed description are exemplary, and are intended to provide further explanation of the invention as claimed.

### DESCRIPTION OF THE DRAWINGS

FIG. 1 is a diagram schematically illustrating a network wherein the server and client machines are connected;

FIG. 2A is a diagram schematically illustrating the modules of the perpetually decreasing group pricing system;

FIG. 2B is a diagram schematically illustrating the data points of the perpetually decreasing group pricing system;

FIG. 3 is a flowchart illustrating the perpetually decreasing group pricing system;

FIG. 4A is a flowchart illustrating the perpetually decreasing group pricing system;

FIG. 4B is a flowchart illustrating the perpetually decreasing group pricing system;

FIG. 5 is a diagram schematically illustrating a computer system utilized by the perpetually decreasing group pricing system.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

In an economic environment comprising a business and consumer(s), the present invention 100 creates a group purchase model 300 whose price declines as more buyers place orders, thus increasing the bargaining position of the group. This involves receiving price and volume data points 302 from the business, accepting sales orders from buyers 306, and offering an interface to display current pricing and volume during a specified time frame 326. This is accomplished using an interpolation module 202, a purchase tracking module 204, a transaction module 206, and an interface module 208. These modules work in conjunction to create an automated interactive pricing model 300 in the group purchase dynamic over a specified time frame.

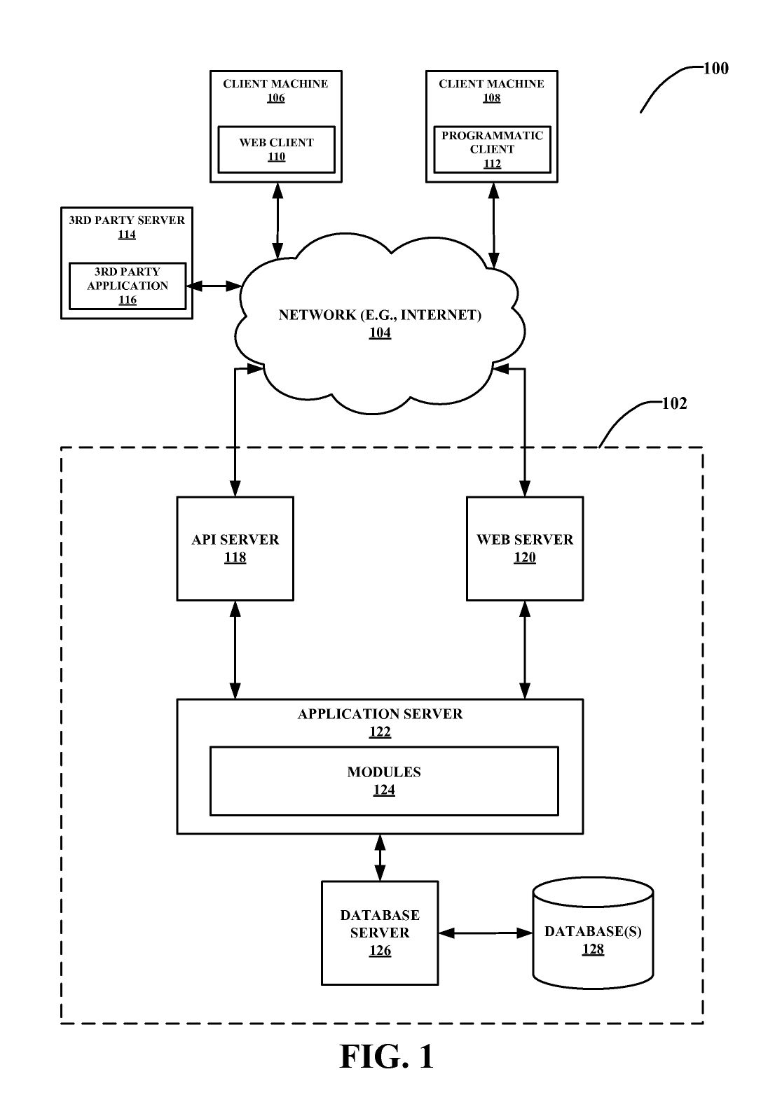

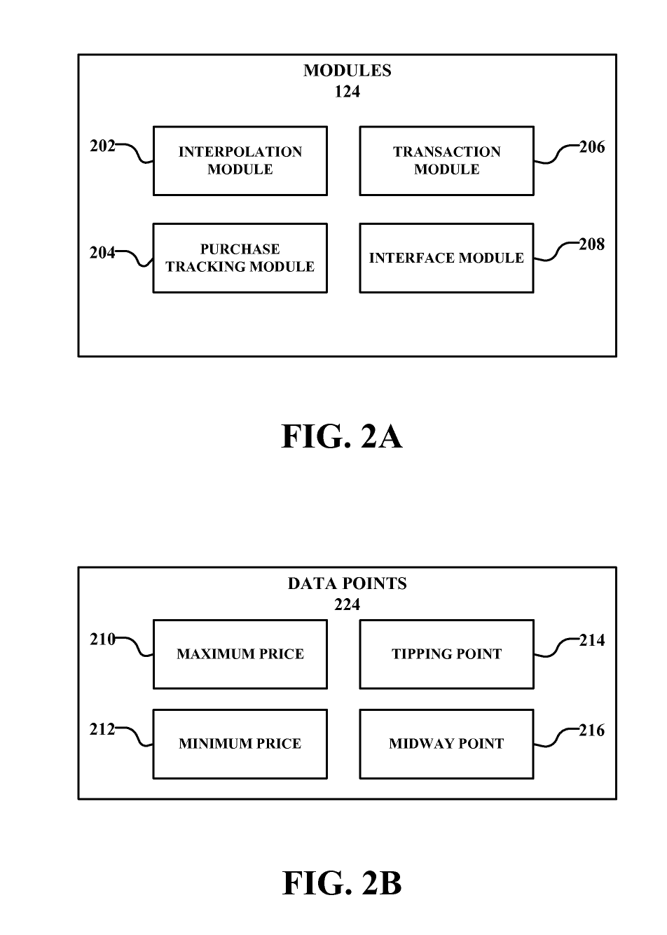

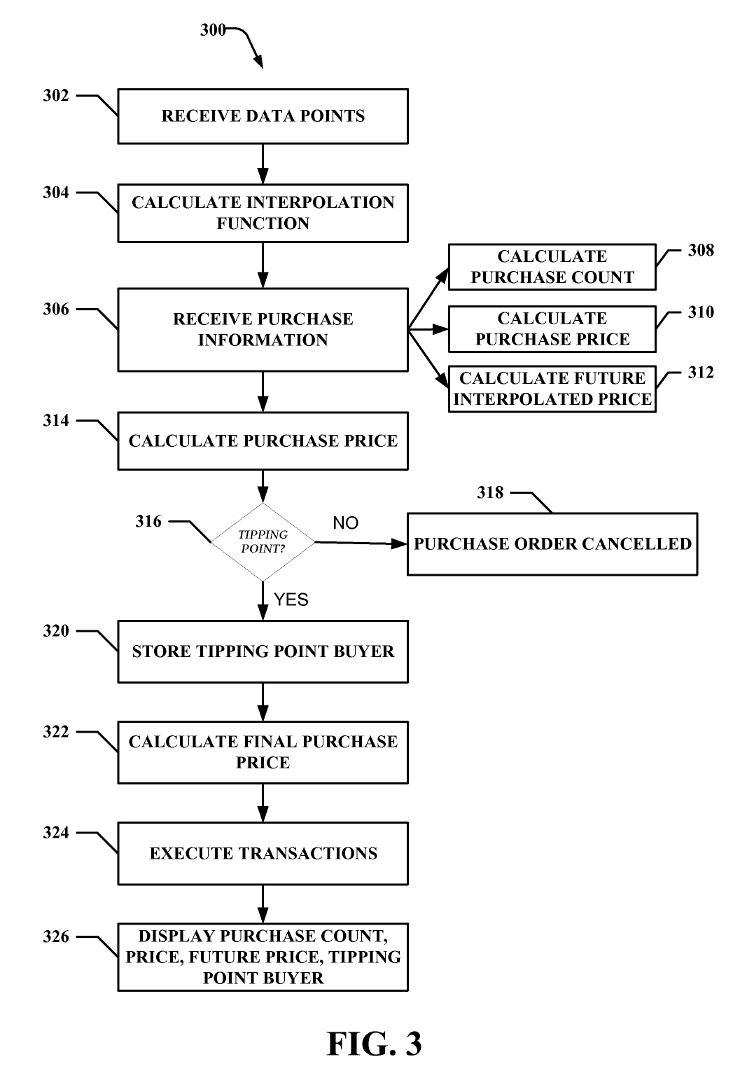

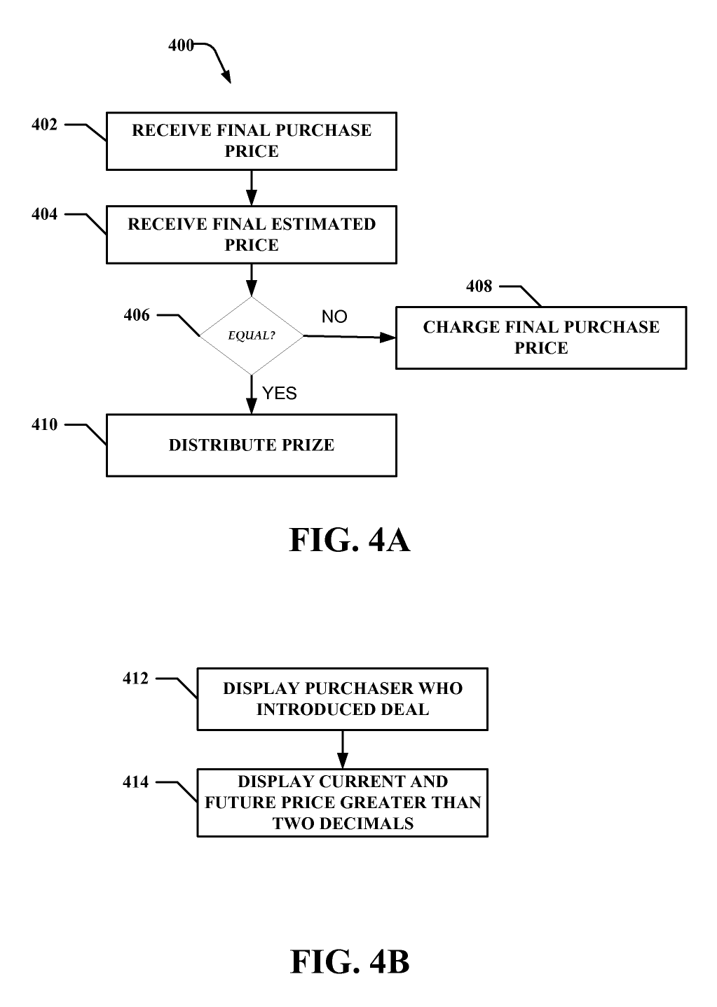

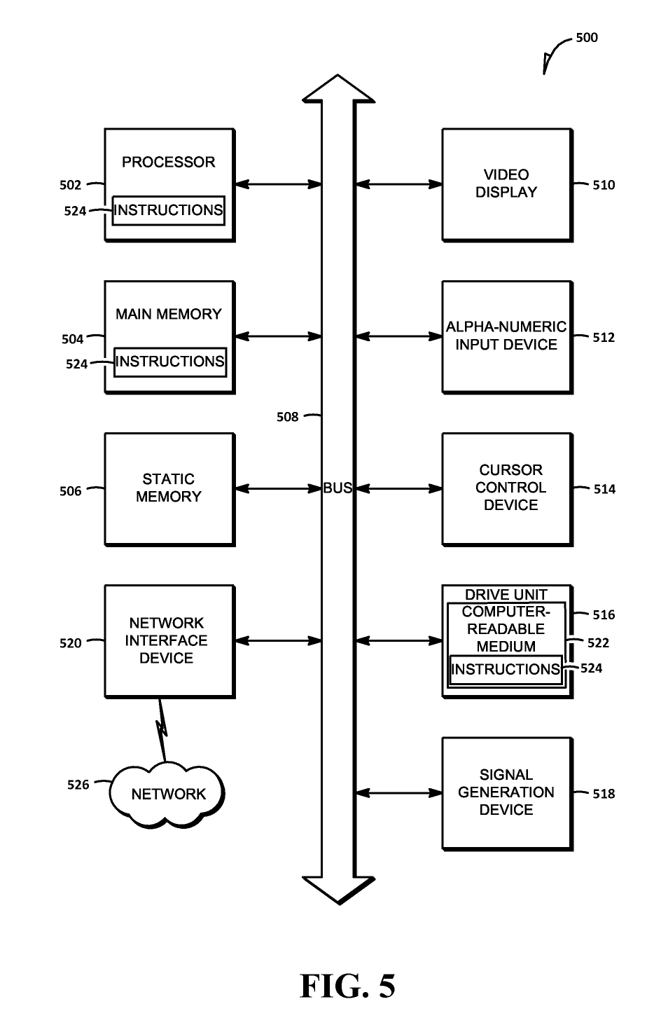

FIG. 1 depicts a block diagram of a computer system 100 suitable for implementing aspects of the present invention. As shown in FIG. 1, computer system 100 includes the perpetually decreasing price system 102, which interconnects major subsystems such as an API server 118, web server 120, application server 122, and database server 126 having a storage means 522. The application server 122 consists of several modules 124, and a database 128 exists on the database server 126. The perpetually decreasing price system 102 connects to client machines 106 and 108, as well as 3rd party servers 114, through a network 104. Web clients 110 and programmatic clients 112 exist on the client machines 106 and 108, respectively, and 3rd party applications 116 that exist on the third party server 114.

The interpolation module 202 will receive the data input 302 from the business and return the interpolation function 304 for prices as compared to customer volume. The interpolation module 202 will receive, from the business, a set of 3 or more data points 302 comprising price and volume pairings 224. These data points 224 comprise the retail price 210, tipping point 214, midway point 216, and manufacturing price 212 and volume points. Alternatively, the retail 210 and manufacturing 212 price can be expressed as extreme values for the maximum 210 and minimum 212 price and volume points. The tipping point 214 is the price before which the buyers are not committed to buy and the seller is not committed to sell 318. The midway point 216 is the price where a substantial number of customers have made purchases and the purchase price will not fall dramatically as sales continue.

These points 224 are received by the interpolation module 202, which outputs a continuous interpolation function 304 to determine a price to volume relationship. The business can then implement this pricing model on an interactive platform accessed by the customer(s) with a timeframe determined by the business 300. The interpolation algorithm relies on exponential approximation between each of the data points 224, while ensuring the asymptotic decay remains above the minimum price point 212 provided by the business. An optimization process can also be used to smooth this function to its desired level of continuity.

In an alternative embodiment, the business many input any number of specified price to volume points 224 between the maximum 210 and minimum 212 price values. Each point 224 can then be used as to calculate an exact exponential interpolation 304 between the maximum price 210, minimum price 212, and the given price point. The function which lies below all specified input price points will then be selected as the optimal price to volume function, which eliminates all discontinuities of higher order.

In a further alternative embodiment, the algorithm could implement exponential interpolation for only the final two points to ensure acceptable asymptotic behavior. The remaining points can be calculated using spline interpolation of a desired degree, or similar polynomial approximations from numerical analysis. This method can ensure that the desired degree of continuity can be achieved while still fitting exactly within the desired price points inputted by the business.

The purchase tracking module 204 will receive and store the list of consumers who have purchased the offer during the active timeframe 306, as well as their purchasing data. Alternatively, the purchase tracking module will record the price tier of each consumer when the purchase is made, as well as the total number of consumers in the purchasing group during the active timeframe. The purchase tracking module will further calculate a total purchase count 308, a current purchase price 310, and a future interpolated price 312, as well as store purchase data for the tipping point buyer 320 whose purchase reduces the current purchase price to the tipping point. In the preferred embodiment, the active timeframe will comprise 1 day, although any timeframe can be used.

The transaction module 206 will receive data from the purchase tracking module 204 to provide the final number of group members who have purchased the offer 308. Data from the interpolation module 202 can then be used to calculate the final price 322. All users listed in the purchase tracking module 204 will then be charged the final price 322 and informed of the transaction at the end of the timeframe, so long as the tipping point 214 has been satisfied. In an alternate embodiment, each purchaser will be charged the price of the price tier they were in when the purchase was made. In a further alternative embodiment, each purchaser will be charged their original purchase price, as calculated by the interpolation module 202.

The interface module 208 will access data from the above modules to create a display to inform consumers of the current count of buyers that have purchased the offer, current purchase price for all users involved, and the future interpolated prices if more users are added to the purchasing group 326. The buyer count is received from the purchase tracking module 204, while other values are received from the interpolation module 202. The current and future interpolated prices 304 can be calculated and displayed to a decimal point greater than two 414 to further incentivize purchases during high-volume sales.

This interface can interactively be shown on the business website or a third party site on which the main advertising occurs. Included in this display is the buyer who introduced the deal 412, the buyer who satisfied the tipping point 320, and the most recent consumer's name and purchase price 326, which becomes the price that is applied to all previous and future consumers of the service or goods during the timeframe.

In addition to the pricing model, the present invention offers an incentivized guessing game 400. Upon the time of purchase, the consumers are given an input field to predict the price estimated price of the service or goods at the expiration of the timeframe 402. This data is stored by the purchase tracking 204 module for reference after the timeframe as elapsed. The first consumer in the database to accurately predict the final price 402 determined by the interpolation module 202 is given a prize provided by the business 410. This prize is suggested by the present invention to be their purchase for free, but variants can be explored. This buyer may also be included in the interface module display.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A system for perpetually decreasing group pricing comprising:
an interpolation module configured to receive a set of data points comprising price and volume pairings and configured to output a continuous interpolation function to determine a price to volume relationship, said price and volume pairings further comprising a maximum point, minimum point, and tipping point;
a purchase tracking module configured to receive a list of purchases and purchase data during an active timeframe, configured to calculate a current purchase count, a current purchase price, and a future interpolated price, and configured to store the tipping point buyer whose purchase reduces the current purchase price to the tipping point;
a transaction module configured to calculate the final purchase price for each buyer as the current purchase price at the expiration of said active timeframe and configured to execute all transactions so long as the final purchase price is less than or equal to said tipping point; and
an interface module configured to display said current purchase count, said current purchase price, said future interpolated price, and said tipping point buyer;
wherein a seller will input said data points and receive a continuous interpolation function which interpolates the pricing information for an entire range of customer volumes, and wherein consumers will agree to a purchase offer whose price will decrease as defined by said continuous interpolation function.

2. The perpetually decreasing group pricing system of claim 1, wherein said maximum point further comprises a retail price, said minimum price further comprises a manufacturing price, said tipping point further comprises a price before which buyers have no obligation to buy and sellers have no obligation to sell, and wherein said price and volume pairings of said interpolation module further comprises a midway point where a substantial number of customers have made purchases and said current purchase price will not continue to fall dramatically as sales continue.

3. The perpetually decreasing group pricing system of claim 1, wherein said active timeframe further comprises one day.

4. The perpetually decreasing group pricing system of claim 1, further comprising a guessing game, wherein said purchase tracking module is configured to receive a final estimated price, and wherein all purchasers whose final estimated price is equal to said final purchase price will receive a prize.

5. The perpetually decreasing group pricing system of claim 4, wherein said prize is equal to the final purchase price.

6. The perpetually decreasing group pricing system of claim 1, wherein said interface module is further configured to display the purchaser who introduced the deal.

7. The perpetually decreasing group pricing system of claim 1, wherein said interface is further configured to display said current and future interpolated purchase price greater than two decimal points.

8. A processor-implemented method for perpetually decreasing group pricing, the method comprising:
receiving a set of data points comprising price and volume pairings and further comprising a maximum point, minimum point, and tipping point;
calculating a continuous interpolation function to determine a price to volume relationship;
receiving a list of purchases and purchase data during an active timeframe;
calculating a current purchase count, a current purchase price, and a future interpolated price;
storing on a computer readable medium the tipping point buyer whose purchase reduces the current purchase price to the tipping point;
calculating the final purchase price for each buyer as the current purchase price at the expiration of said active timeframe
executing all transactions so long as the final purchase price is less than or equal to said tipping point; and
displaying said current purchase count, said current purchase price, said future interpolated price, and said tipping point buyer;
wherein a seller will input said data points and receive a continuous interpolation function which interpolates the pricing information for an entire range of customer volumes, and wherein consumers will agree to a purchase offer whose price will decrease as defined by said continuous interpolation function.

9. The method of claim 8, wherein said maximum point further comprises a retail price, said minimum price further comprises a manufacturing price, said tipping point further comprises a price before which buyers have no obligation to buy and sellers have no obligation to sell, and wherein said price and volume pairings of said interpolation module further comprises a midway point where a substantial number of customers have made purchases and said current purchase price will not continue to fall dramatically as sales continue.

10. The method of claim 8, wherein said active timeframe further comprises one day.

11. The method of claim 8, further comprising receiving a final estimated price, and wherein all purchasers whose final estimated price is equal to said final purchase price will receive a prize.

12. The method of claim 11, wherein said prize is equal to the final purchase price.

13. The method of claim 8, further comprising displaying the purchaser who introduced the deal and displaying said current and future interpolated purchase price greater than two decimal points.

14. A non-transitory computer-readable storage medium storing a set of instructions that, when executed by a processor, cause the processor to perform operations, comprising:
receiving a set of data points comprising price and volume pairings and further comprising a maximum point, minimum point, and tipping point;
calculating a continuous interpolation function to determine a price to volume relationship;
receiving a list of purchases and purchase data during an active timeframe;
calculating a current purchase count, a current purchase price, and a future interpolated price;
storing on a computer readable medium the tipping point buyer whose purchase reduces the current purchase price to the tipping point;
calculating the final purchase price for each buyer as the current purchase price at the expiration of said active timeframe
executing all transactions so long as the final purchase price is less than or equal to said tipping point; and
displaying said current purchase count, said current purchase price, said future interpolated price, and said tipping point buyer;
wherein a seller will input said data points and receive a continuous interpolation function which interpolates the pricing information for an entire range of customer volumes, and wherein consumers will agree to a purchase offer whose price will decrease as defined by said continuous interpolation function.

15. The non-transitory computer-readable storage medium of claim 14, wherein said maximum point further comprises a retail price, said minimum price further comprises a manufacturing price, said tipping point further comprises a price before which buyers have no obligation to buy and sellers have no obligation to sell, and wherein said price and volume pairings of said interpolation module further comprises a midway point where a substantial number of customers have made purchases and said current purchase price will not continue to fall dramatically as sales continue.

16. The non-transitory computer-readable storage medium of claim 14, wherein said active timeframe further comprises one day.

17. The non-transitory computer-readable storage medium of claim 14, further comprising receiving a final estimated price, and wherein all purchasers whose final estimated price is equal to said final purchase price will receive a prize.

18. The non-transitory computer-readable storage medium of claim 17, wherein said prize is equal to the final purchase price.

19. The non-transitory computer-readable storage medium of claim 14, further comprising displaying the purchaser who introduced the deal and displaying said current and future interpolated purchase price greater than two decimal points.
